(19) United States
(12) Patent Application Publication
(10) Pub. No.: US 2014/0173440 A1
(43) Pub. Date: Jun. 19, 2014

(54) SYSTEMS AND METHODS FOR NATURAL INTERACTION WITH OPERATING SYSTEMS AND APPLICATION GRAPHICAL USER INTERFACES USING GESTURAL AND VOCAL INPUT

(71) Applicant: IMIMTEK, INC., Sunnyvale, CA (US)

(72) Inventors: Carlo Dal Mutto, Mountain View, CA (US); Abbas Rafii, Palo Alto, CA (US)

(73) Assignee: IMIMTEK, INC., Sunnyvale, CA (US)

(21) Appl. No.: 13/899,537

(22) Filed: May 21, 2013

Related U.S. Application Data
(60) Provisional application No. 61/797,776, filed on Dec. 13, 2012.

(51) Int. Cl. G06F 3/01

(52) U.S. Cl. CPC G06F 3/017
USPC 715/728

(57) ABSTRACT

Systems and methods for natural interaction with graphical user interfaces using gestural and vocal input in accordance with embodiments of the invention are disclosed. In one embodiment, a method for interpreting a command sequence that includes a gesture and a voice cue to issue an application command includes receiving image data, receiving an audio signal, selecting an application command from a command dictionary based upon a gesture identified using the image data, a voice cue identified using the audio signal, and metadata describing combinations of a gesture and a voice cue that form a command sequence corresponding to an application command, retrieving a list of processes running on an operating system, selecting at least one process based upon the selected application command and the metadata, where the metadata also includes information identifying at least one process targeted by the application command, and issuing an application command to the selected process.

### CROSS-REFERENCE TO RELATED APPLICATIONS

The current application claims priority under 35 U.S.C. 119(e) to U.S. Patent Application Serial No. 61/797,776, filed Dec. 13, 2012, the disclosure of which is incorporated herein by reference.

### FIELD OF THE INVENTION

The present invention relates generally to human-machine interaction and more specifically to systems and methods for issuing operating system or application commands using gestural and vocal input.

### BACKGROUND OF THE INVENTION

A common operation in human-machine interaction is the user navigation of an operating system graphical interface. Graphical interfaces might belong to but are not limited to the desktop paradigm and tiles paradigm. In desktop-paradigm interfaces, the screen appears as a desktop populated by icons, gadgets, widgets, bars and buttons. In tiles-paradigm interfaces, the screen appears as a set of tiles and a set of buttons, bars and hidden objects that can appear by performing specific operations. Typical actions performed by the user are mouse pointing, object selection (an object might be but is not limited to icons, gadgets, widgets, bars and buttons), click, double-click, right-click, scrolling and swiping. Classically this type of interaction is performed via mouse, track-pad and touch-screens.

Once an object in the interface is selected, it is possible that such object requires some text-like type of input (e.g., writing some text to fill a blank field, writing an email). Typically this kind of input is performed via keyboard, virtual keyboard or voice. Interpretation of voice input typically utilizes automatic speech recognition (or speech processing). Speech recognition involves determining what words a user has spoken. A variety of algorithms can be used to determine what words known to the system most likely match up to the recorded speech from the user. The result can be used to issue a command or provide speech-to-text input.

Early speech recognition systems were limited to discrete speech, where a user must pause between each spoken word. Because of simpler computation, discrete speech systems can be faster and/or more accurate. Many modern systems are capable of continuous speech where a user can speak in a natural fluid manner, but recognition may not be as accurate. Modern systems can have other trade-offs, such as recognizing many users (with variation in accent and speech patterns) with a small vocabulary of commands versus recognizing a limited number of users (via training algorithms) with a large vocabulary of commands.

Speech recognition systems typically use various combinations of a number of standard techniques to interpret a sequence of words or phonemes (basic units of a language that represent different sounds). Many techniques are based on statistical models such as Hidden Markov Models and neural networks to match captured sounds to a database of known words or phonemes.

### SUMMARY OF THE INVENTION

Systems and methods for natural interaction with operation systems and application graphical user interfaces using gestural and vocal input in accordance with embodiments of the invention are disclosed. In one embodiment, a method for interpreting a command sequence that includes a gesture and a voice cue to issue an application command to at least one process using a natural interaction user interface system that includes a processor and memory containing a command dictionary includes receiving image data using a natural interaction user interface system, receiving an audio signal using a natural interaction user interface system, selecting, using a natural interaction user interface system, an application command from a command dictionary of application commands based upon a gesture identified using the image data, a voice cue identified using the audio signal, and metadata describing combinations of a gesture and a voice cue that form a command sequence corresponding to an application command within the command dictionary, retrieving a list of processes running on an operating system using a natural interaction user interface system, selecting at least one process from the list of processes based upon the selected application command and the metadata using a natural interaction user interface system, where the metadata also includes information identifying at least one process targeted by the application command, and issuing an application command to the selected at least one process using a natural interaction user interface system.

In a further embodiment, the metadata includes gesture metadata, where the gesture metadata identifies a plurality of voice cues that combine with a gesture to form a command sequence corresponding to an application command within the command dictionary, and selecting an application command from a dictionary of application commands also includes identifying a gesture using the image data, and identifying a voice cue from the plurality of voice cues using the audio signal and the gesture metadata.

In another embodiment, gesture metadata also includes information identifying at least one process to target with an application command associated with a command sequence containing a gesture and selecting at least one process from the list of processes using a natural interaction user interface system also includes selecting at least one process based upon the gesture metadata.

In a still further embodiment, the metadata includes voice cue metadata, where the voice cue metadata identifies a plurality of gestures that combine with a voice cue to form a command sequence corresponding to an application command within the command dictionary, and selecting an application command from a dictionary of application commands also includes identifying a voice cue using the audio signal, and identifying a gesture from the plurality of gestures using the image data and the voice cue metadata.

In still another embodiment, voice cue metadata also includes information identifying at least one process to target with an application command associated with a command sequence containing a voice cue and selecting at least one process from the list of processes using a natural interaction user interface system also includes selecting at least one process based upon the voice cue metadata.

In a yet further embodiment, selecting an application command from a dictionary of application commands also includes identifying a gesture using the image data, identifying a voice cue using the audio signal, continuously updating the image data and the identification of the gesture, and continuously updating the audio signal and the identification of the voice cue.

In yet another embodiment, receiving image data also includes capturing image data using at least one camera.

In a further embodiment again, receiving image data also includes capturing image data using at least two cameras.

In another embodiment again, the image data includes depth information that can be used to identify a three-dimensional gesture.

In a further additional embodiment, the depth information includes a depth map.

In another additional embodiment, receiving image data also includes capturing image data using an ultrasonic sensor.

In a still yet further embodiment, receiving image data also includes capturing image data using one or more devices in which multiple view-points are included in a single chip.

In still yet another embodiment, at least one device in which multiple view-points are included in a single chip is a computational camera.

In a still further embodiment again, receiving an audio signal also includes capturing an audio signal using at least one microphone.

In still another embodiment again, the gesture is a static gesture.

In a still further additional embodiment, the image data includes a sequence of multiple images captured over time and the gesture is a dynamic gesture.

Still another additional embodiment also includes retrieving command sequence metadata based upon the gesture and the voice cue, where the command sequence metadata includes information that can be used to identify at least one application to target with an application command associated with the command sequence, and where selecting at least one process from the list of processes using a natural interaction user interface system also includes selecting at least one process based upon the command sequence metadata.

In a yet further embodiment again, the natural interaction user interface system includes a user device and a recognition server that can communicate over a network.

In yet another embodiment again, a natural interaction user interface system for providing user input to an operating system includes a processor, memory, where the memory includes an operating system, a user application, a natural interaction interface application, a database that includes metadata and a command dictionary of application commands, a display, at least one camera configured to capture image data, and at least one microphone configured to generate an audio signal, where the processor is configured by the natural interaction interface application to select an application command from the command dictionary of application commands based upon a gesture identified using the image data, a voice cue identified using the audio signal, and metadata describing combinations of a gesture and a voice cue that form a command sequence corresponding to an application command within the command dictionary, retrieve a list of processes running on an operating system, select at least one process from the list of processes based upon a selected application command and the metadata, where the metadata also includes information identifying at least one process targeted by an application command, and issue a selected application command to the selected at least one process.

In a yet further additional embodiment, the metadata includes gesture metadata, where the gesture metadata identifies a plurality of voice cues that combine with a gesture to form a command sequence corresponding to an application command within the command dictionary, and where the processor being configured to select an application command from a dictionary of application commands also includes the processor being configured to identify a gesture using the image data, and identify a voice cue from the plurality of voice cues using the audio signal and the gesture metadata.

In yet another additional embodiment, gesture metadata also includes information identifying at least one process to target with an application command associated with a command sequence containing the gesture and the processor being configured to select at least one process from the list of processes also includes the processor being configured to select at least one process based upon gesture metadata.

In a further additional embodiment again, the metadata includes voice cue metadata, where the voice cue metadata identifies a plurality of gestures that combine with a voice cue to form a command sequence corresponding to an application command within the command dictionary, and the processor being configured to select an application command from a dictionary of application commands also includes the processor being configured to identify a voice cue using an audio signal, identify a gesture from the plurality of gestures using image data and gesture metadata.

In another additional embodiment again, voice cue metadata also includes information identifying at least one process to target with an application command associated with a command sequence containing the voice cue and the processor being configured to select at least one process from the list of processes also includes the processor being configured to select at least one process based upon voice cue metadata.

In a still yet further embodiment again, the processor being configured to select an application command from a dictionary of application commands also includes the processor being configured to identify a gesture using the image data, identify a voice cue using the audio signal, continuously update the image data and the identification of the gesture, and continuously update the audio signal and the identification of the voice cue.

In still yet another embodiment again, the at least one camera configured to capture image data includes at least two cameras.

In a still yet further additional embodiment, the image data includes depth information that can be used to identify three-dimensional gestures.

In still yet another additional embodiment, the image data includes a depth map.

In a yet further additional embodiment again, the image data includes information at ultrasonic wavelengths.

In a yet further additional embodiment again, at least one of the at least one cameras is configured to capture image data using one or more devices in which multiple view-points are included in a single chip.

In a still yet further additional embodiment again, at least one camera is a computational camera.

In still yet another additional embodiment again, the gesture is a static gesture.

In another further embodiment, the image data includes multiple images and the gesture is a dynamic gesture.

In still another further embodiment, the processor is also configured by the natural interaction interface application to retrieve command sequence metadata from the database based upon a gesture and a voice cue, where the command sequence metadata includes information that can be used to identify at least one application to target with an application command associated with the command sequence, and where the processor being configured to select at least one process from the list of processes using a natural interaction user interface system also includes the processor being configured to select at least one process based upon command sequence metadata.

In yet another further embodiment, the processor is also configured by the natural interaction interface application to transmit the image data to a recognition server and the gesture is identified using the image data by a recognition server.

In another further embodiment again, the processor is also configured by the natural interaction interface application to transmit the audio signal to a recognition server and the voice cue is identified using the audio signal by a recognition server.

### BRIEF DESCRIPTION OF THE DRAWINGS

FIG. 1 conceptually illustrates a natural interaction user interface system configured to process command sequences in accordance with an embodiment of the invention.

FIG. 2 conceptually illustrates a command processing system in accordance with an embodiment of the invention.

FIG. 3 is a system diagram of a natural interaction user interface system that can connect to a network in accordance with embodiments of the invention.

FIG. 4 is a flow chart illustrating a process for interpreting command sequences where a gesture provides semantics for a subsequent voice cue in accordance with embodiments of the invention.

FIG. 5 is a flow chart illustrating a process for interpreting command sequences where a voice cue provides semantics for a subsequent gesture in accordance with embodiments of the invention.

FIG. 6 is a flow chart illustrating a process for interpreting command sequences where a gesture and a voice cue jointly specify an application command in accordance with embodiments of the invention.

### DETAILED DISCLOSURE OF THE INVENTION

Turning now to the drawings, systems and methods for natural interaction with operating systems and application graphical user interfaces using gestural and vocal input in accordance with embodiments of the invention are illustrated. In various embodiments of the invention, the interaction between gestural input and vocal input is exploited in order to complement each other, or overcome the limitations and ambiguities that may be present when each approach is utilized separately. The input command sequence of gestures and voice cues can be interpreted to issue commands to the operating system or applications supported by the operating system. In many embodiments, a database or other data structure contains metadata for gestures, voice cues, and/or commands that can be used to facilitate the recognition of gestures or voice cues. Metadata can also be used to determine the appropriate operating system or application function to initiate by the received command sequence.

In many embodiments of the invention, a natural interaction user interface system interprets a combination of gestural input and vocal input to control an operating system or one or more applications. Gestural input can include one or more gestures made by a user's hand or other instrument. Gestures can be captured by the system in 2-dimensions or 3-dimensions. Gestures can also be static (stationary) or dynamic (a motion). Systems and methods for performing hand tracking and identifying gestures that can be utilized in accordance with embodiments of the invention are disclosed in U.S. patent application Ser. No. 13/899,520 entitled “Systems and Methods for Tracking Human Hands Using Parts Based Template Matching” to Mutto et al. Vocal input can include one or more voice cues that are words or sequences of words spoken by a user. Voice cues can also include other sounds or signals generated by a user.

A natural interaction user interface system in accordance with many embodiments of the invention can include cameras to capture gestural input and microphones to capture vocal input. Gestural input can also be captured by touch screens or other visual tools.

In several embodiments of the invention, one or more gestures are used to initiate the command sequence and/or to provide semantics for subsequent voice cues. For example, a gesture of holding two fingers in a V-shape can be recognized as the beginning of a command sequence and the voice cues that follow are captured and interpreted. In other embodiments, any of a variety of gestures can be utilized to indicate to a computing device that the user is about to provide a voice cue and/or the semantics of the subsequent voice cue(s).

In other embodiments of the invention, one or more voice cues initiates and provides semantics for subsequent gestures. For example, saying “volume” specifies that a following rolling gesture is applied to increase sound volume of a media application, while the “track” command would indicate that the same gesture relates to changing audio tracks. In other embodiments, any of a variety of voice cues can be utilized to indicate to a computing device that the user is about to provide a gesture and/or the semantics of the subsequent gesture(s).

In further embodiments of the invention, the combination of a gesture and voice cue are used jointly to specify an instruction or operation.

A command sequence includes one or more gestures and one or more voice cues. The command sequence (combination and/or order of gesture and voice cue) is associated with an application command in a command dictionary. The application command can be issued to a process or a class of processes that are running on the operating system or to the operating system itself.

In many embodiments of the invention, a natural interaction user interface system can use various functions and/or resources of an operating system to obtain information concerning the processes that are running on the operating system. Processes can be active or running in the background. Processes can include applications or other executables. An operating system may have a scheduler function, often implemented as an application programming interface (API) function. The scheduler function returns a list of running processes. In various embodiments of the invention, a command sequence identified based upon a sequence of one or more gestures and one or more voice cues is provided to a specific process or class of processes selected from the list. The process or class of processes can be selected based upon metadata associated with the command sequence in the command dictionary, or with a gesture or voice cue in the command sequence that directly indicates a specific target application or class of applications. Natural interaction user interface systems in accordance with embodiments of the invention are discussed below.

### Natural Interaction User Interface System

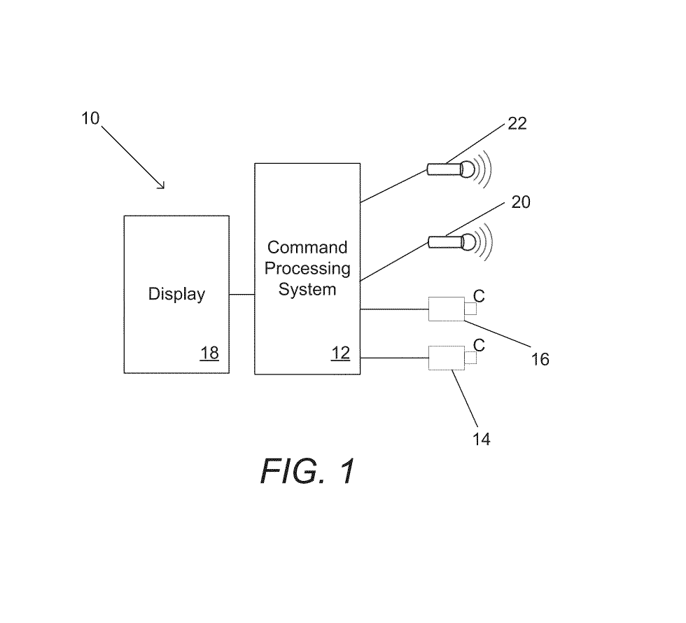

In many embodiments of the invention, a natural interaction user interface system is utilized to process command sequences that include one or more gestures and one or more voice cues. A natural interaction user interface system in accordance with an embodiment of the invention is illustrated in FIG. 1. The natural interaction user interface system 10 includes a command processing system 12 configured to receive image data captured by at least one camera 14. Other embodiments include at least two cameras 14 and 16 and/or additional image sensors including but not limited to infrared (IR) cameras, ultrasonic sensors, and/or other types of image sensors including sensors capable of generating dense depth maps for images captured using the at least one camera 14. Image data can include information from visible and/or non-visible wavelengths, such as infrared or ultrasound, encoded into an electrical signal. Moreover, image data can include depth information, e.g., via a depth map generated by a sensor or camera or in the form of disparity between multiple views of scene from which a depth map can be generated, which can be used in recognizing 3-dimensional gestures. In several embodiments of the invention, image data is captured by a system or device in which multiple view-points are integrated into a single chip (such as sensors known as “computational cameras,” “light field cameras,” or “array cameras”). In various embodiments of the invention, 3D sensors such as time-of-flight cameras can be used to capture image data with depth information.

In many embodiments, the natural interaction user interface system processes the captured image data to determine the location and pose of a human hand. Based upon the location and pose of a detected human hand, the command processing system can detect gestures. Gestures can be static (i.e. a user placing her or his hand in a specific pose) or dynamic (i.e. a user transitions her or his hand through a prescribed sequence of poses). Based upon changes in the pose of the human hand and/or changes in the pose of a part of the human hand over time, the command processing system can detect dynamic gestures. Gestures can be two-dimensional (2D) or three-dimensional (3D). Two-dimensional gestures can generally be determined from image data generated from a single viewpoint without the use of depth information. Stated another way, a two dimensional gesture is a gesture that can be observed in a single image (static gesture) or a sequence of images captured from a single viewpoint (dynamic gesture) without reference to depth information or knowledge of the motion of the gesture in three dimensional space. Three-dimensional gestures can be determined using depth information that can be generated by a camera or 3D sensor such as the systems and devices discussed further above, or by a command processing system 12 that receives image data concerning images from different viewpoints. A three-dimensional gesture can involve determining a pose (static gesture) or sequence of poses (dynamic gesture) in three-dimensional space. For example, one gesture may be a hand or finger waving side-to-side in one plane perpendicular to the center line of a camera. A second gesture may be a hand or finger drawing a circle in a second plane in line with the center line of a camera. Without depth information, the two gestures may be perceived to be similar. With depth information of the hand or finger moving toward and away from the camera, the two gestures can be distinguished from each other. Although much of the discussion that follows focuses on gestures made using human hands and human fingers, motion of any of a variety of objects in a predetermined manner can be utilized to initiate object tracking and gesture based interaction in accordance with embodiments of the invention.

In a number of embodiments, the natural interaction user interface system 10 includes a display 18 via which the natural interaction user interface system can present a user interface to the user. By detecting gestures, the natural interaction user interface system can enable the user to interact with the user interface presented via the display. In many embodiments of the invention, the graphical user interface is part of an operating system. In several embodiments of the invention, the display is a touch screen or other interactive device that can also be used to detect gestures from a user.

In many embodiments of the invention, the command processing system 12 is configured to receive an audio signal generated by at least one microphone 20. Other embodiments include at least two microphones 20 and 22. The microphone(s) generate an audio signal from which voice cues can be recognized. As will be discussed further below, a command sequence that includes one or more gestures and one or more voice cues can be recognized by a command processing system to provide a specific command to one or more applications running on the system.

Although a specific natural interaction user interface system including two cameras and two microphones is illustrated in FIG. 1, any of a variety of processing systems configured to capture image data from at least one view and an audio signal can be utilized as appropriate to the requirements of specific applications in accordance with embodiments of the invention. Command processing systems in accordance with embodiments of the invention are discussed further below.

### Command Processing Systems

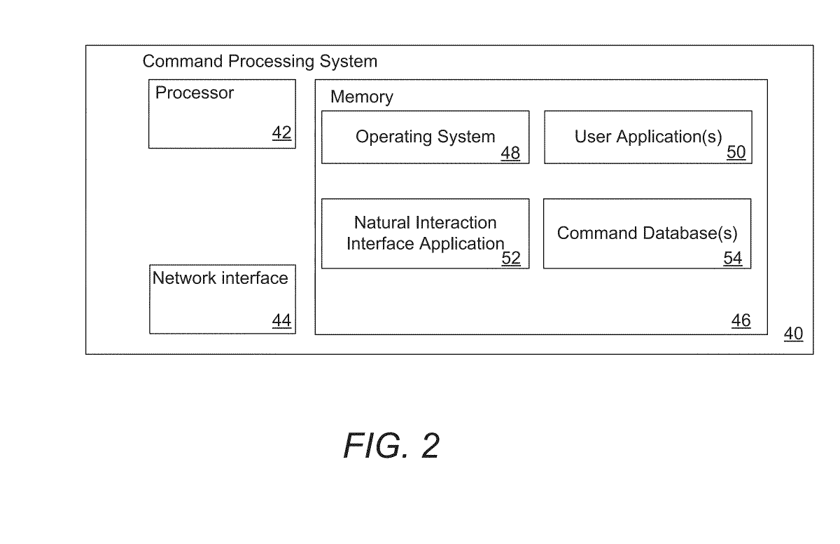

A command processing system in accordance with an embodiment of the invention is illustrated in FIG. 2. The command processing system 40 includes a processor 42, a network interface 44, and memory 46. The memory 46 can include an operating system 48, user application(s) 50, a natural interaction interface application 52, and command database(s) 54.

The operating system 48 can be any of a variety of operating systems such as, but not limited to, Linux, Unix, OSX, Windows, Android, and iOS. User applications 50 can include productivity applications (such as word processors), multimedia applications (such as music or video players), and other applications designed to run on the operating system.

The memory includes a natural interaction interface application 52. As will be discussed in detail further below, the application 52 can configure the processor 42 to determine gestures and voice cues in a command sequence using image data and an audio signal. The command sequence can be used to determine a command to a user application using metadata associated with a command sequence or with a gesture or voice cue in the command sequence.

The memory can also include a command database 54. As will be discussed in greater detail below, a command database can store metadata concerning gestures and voice cues that can be used in the identification of command sequences and an application and/or class of applications that the command sequence targets. The metadata in the command dictionary can be used to facilitate the recognition of command sequences and the application(s) to target with a command. As will be discussed below, natural interaction user interface systems can include devices that communicate over a network. For example, a computing device known as a thin client may have limited resources onboard and may communicate with servers over a network, where the servers perform much of the processing for the thin client. In various embodiments of the invention, a natural interact interface system includes a user device, such as a thin client, and a recognition server that communicate over a network. Where the recognition processing is distributed in this way, some of the components discussed above may be on a user device while other components reside on a recognition server. For example, portions of a command database may be on a user device or on a recognition server according to which of the processing tasks discussed below that utilize the command database are performed on the user device or on the recognition server. Natural interaction user interface systems that can utilize resources over a network to perform identification of command sequences based upon image and audio data in accordance with embodiments of the invention are discussed further below.

### Networked Devices

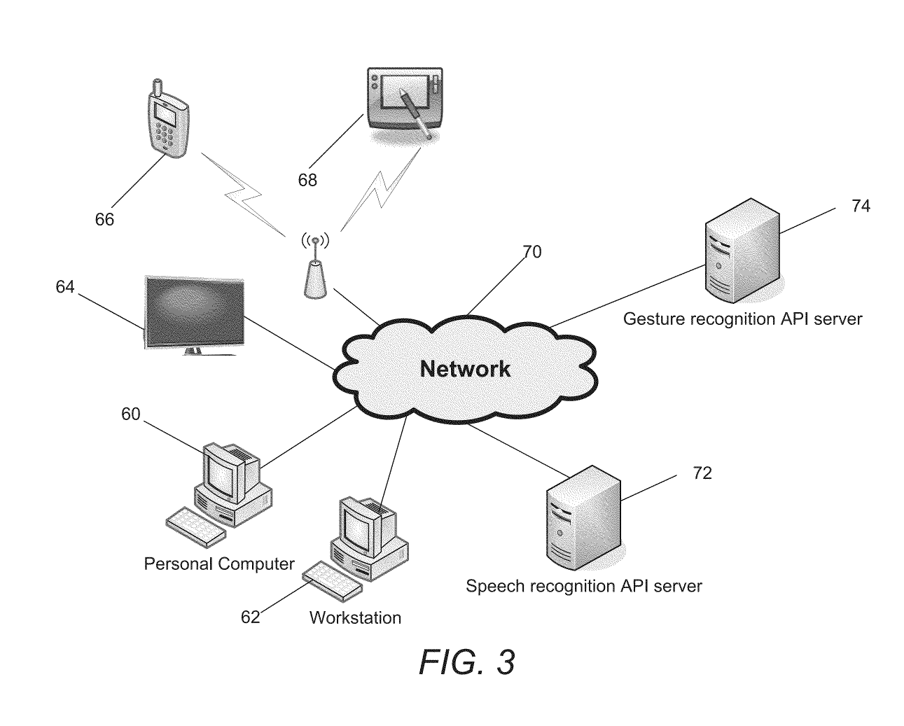

A natural interaction user interface system can be standalone or can connect to a network such as a local area network, wide area network, wireless network, or the internet. Natural interaction user interface systems that can connect to a network in accordance with embodiments of the invention are illustrated in FIG. 3. A natural interaction user interface system can be a personal computer 60, workstation 62, TV or entertainment system 64, mobile device (such as smart phone 66 or tablet 68), in-car electronics system or other computing device. These devices may be connected to a network 70. Networked (network-connected) devices may utilize other computing devices to perform or aid in gesture or speech recognition. Thin clients are a class of devices with limited resources and that utilize servers or other resource-rich devices for many processing tasks. For example, a networked user device may capture an audio signal using microphones, and may utilize network resources to process the audio signal for speech recognition. The user device may send the audio signal, or certain characteristics or portions of the audio signal, to a speech recognition API (applications programming interface) server 72 to assist in speech recognition. Similarly, the user device may send image data captured using cameras (or characteristics or portions of the image data) to a gesture recognition API server to assist in gesture recognition. In various embodiments of the invention, a recognition server can perform speech recognition or gesture recognition or both. In various embodiments of the invention, a user device or a recognition server can perform operations using metadata, command sequences, and application commands that are discussed further below. A user device itself may be referred to as a natural interaction user interface system. Alternatively, a natural interaction user interface system may include a networked user device and one or more other networked computing devices (such as a recognition server) with which the user device can communicate and use to aid in recognizing a gesture and/or voice cue. Gesture, voice cue, and command metadata that can be utilized to facilitate processing of command sequences are discussed further below.

### Gesture, Voice Cue, and Command Metadata

In many embodiments of the invention, metadata is associated with gestures, voice cues, and/or command sequences in a database or other data structure. Gesture metadata associated with a gesture can describe what voice cues may be used simultaneously with the gesture or follow the gesture in a command sequence. Gesture metadata can also describe what applications can be affected by a command sequence that contains the gesture.

Voice cue metadata associated with a voice cue can describe what gestures may be used simultaneously with a voice cue or follow a voice cue in a command sequence. Voice cue metadata can also describe what applications can be affected by a command sequence that contains the voice cue.

Command sequence metadata associated with a command sequence can describe what application or class of applications is affected by the command.

Gesture metadata, voice cue metadata, and command metadata can be stored with semantic information concerning gestures, voice cues, and commands in command databases. For example, a database table can be assigned to a gesture that specifies the gesture, associated voice cues that may follow the gesture, and associated applications that may be affected by the gesture and/or specific combinations of gestures and voice cues. Applications may be referred to individually or as a class of applications, e.g., music player applications, where additional tables indicate the applications that belong to a particular class. Alternatively, applications can be specified by the system resources that they use. For example, a class of applications can be those that utilize USB (universal serial bus) or network communications, or those that utilize an audio output device. A natural interaction user interface system that receives the gesture in a command sequence followed by voice cues can use the database to retrieve a list of potential voice cues that are expected in the command sequence and the application(s) that should receive a command as indicated by the gesture and/or a specific gesture and voice cue combination.

Similarly, a database table can be assigned to a voice cue that specifies the voice cue, associated gestures that may follow the voice cue, and associated applications that may be affected by the voice cue. A natural interaction user interface system that receives the voice cue in a command sequence followed by gestures can use the database table to retrieve a list of potential gestures that are expected in the command sequence and the application(s) that should receive a command as indicated by the voice cue and/or a voice cue and gesture combination.

A command dictionary can include one or more database tables containing command sequences and associated application commands and metadata. A table for a command sequence can include the command sequence (or an identifier for the command sequence), an application command to issue when the command sequence is invoked, and metadata describing the applications which should be targeted by the application command. Application commands can include, by way of example, “play” and “track change” for multimedia applications and “select text” and “scroll” for word processing applications. Any of a variety of application commands can be implemented in accordance with embodiments of the invention subject to the capabilities and limitations of each system. Although databases in accordance with embodiments of the system are discussed in the context of database tables, any of a variety of database structures can be utilized to store semantic information concerning gestures, and voice cues, and metadata concerning command sequences, and applications targeted by command sequences in accordance with embodiments of the invention. Processes for interpreting command sequences to issue application commands are discussed further below.

### Interpreting Command Sequences of a Gesture and Subsequent Voice Cue

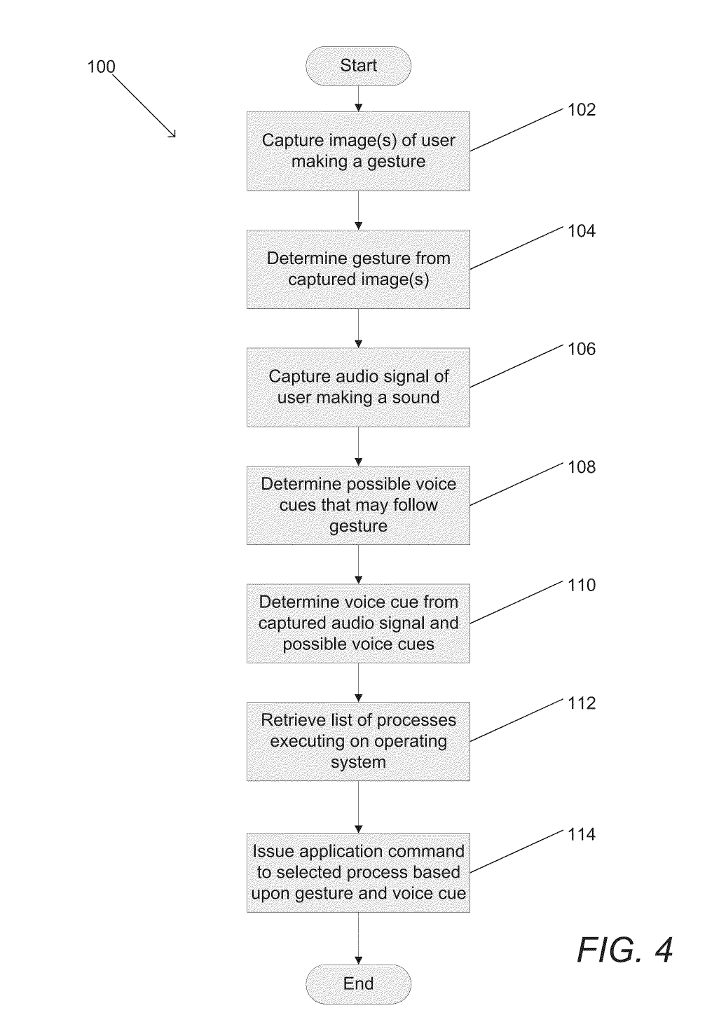

In many embodiments of the invention, a command sequence includes a gesture and a voice cue. The gesture identified from image data provides semantics for the subsequent voice cue identified from an audio signal. A process for interpreting command sequences where a gesture provides semantics for a subsequent voice cue in accordance with embodiments of the invention is illustrated in FIG. 4. The process includes capturing (102) one or more image(s) of a user making a gesture using one or more cameras. Each camera may capture one image or may capture multiple images over time. In several embodiments of the invention, multiple cameras capture images from different viewpoints. The captured images can be used to determine (104) one or more gestures that were made. A gesture that is static (i.e. a user placing her or his hand in a specific pose) can typically be recognized from a single image. A gesture that is dynamic (i.e. a user transition her or his hand through a prescribed sequence of poses) typically involves analysis of multiple images captured over time to be recognized.

The process includes capturing (106) an audio signal of a user making a sound, such as a voice cue. The previously determined gesture provides semantics for identification of the voice cue. That is, gesture metadata associated with the gesture can be used to assist in identifying a subset of possible voice cues that combine with the recognized gesture to yield a valid command sequence. In many embodiments of the invention, any of a variety of automatic speech recognition techniques can be used to identify the voice cue from the audio signal. Several techniques include utilizing a Hidden Markov Model (HMM) to find the maximum likelihood that the characteristics of the audio signal match a particular voice cue. In several embodiments of the invention, gesture metadata includes a list of potential voice cues that may follow a gesture in a command sequence. An HMM can utilize (108) the list of potential voice cues to facilitate or limit the search for a matching voice cue. The voice cue is determined (110) using an automatic speech recognition technique.

In several embodiments of the invention, a device utilizes external resources (such as servers over a network) for automated speech recognition. The device sends an audio signal, a portion of an audio signal, or characteristics of an audio signal to a speech recognition API (applications programming interface) server. The speech recognition API server processes the audio signal (e.g., using an HMM and/or other algorithms) to identify a voice cue and returns data identifying the voice cue to the device. In further embodiments of the invention, the device can send gesture metadata that lists possible voice cues to the speech recognition API server. The server can utilize the metadata in identifying the voice cue similar to the method described above. Similarly, a device can utilize a gesture recognition API server to identify gestures in image data. The device can send image data, a portion of image data, or characteristics of image data to a gesture recognition API server. The gesture recognition API server processes the image data to identify a gesture and returns the gesture to the device.

A list of processes running on the operating system is retrieved (112). Many operating systems provide a method to list running processes, such as a scheduler. In several versions of the Windows operating system, such as Windows XP, the applications programming interface (API) function CreateToolhelp32Snapshot can be used to list processes and threads in the system, as well as other related information. Another function is EnumProcesses that can be found in the Process Status API library, which returns an array with identifiers of all processes in the system. Any of a variety of other functions can be utilized to request a list of processes and/or process status from the operating system according to the capabilities of specific operating systems in accordance with embodiments of the invention.

An application command is issued (114) to a selected process or class or processes from the list of processes based upon the command sequence of the gesture and voice cue. The application command can be determined in a variety of ways. As discussed further above, a command dictionary can contain database tables containing command sequences and associated application commands and metadata. The process can utilize metadata describing combinations of a gesture and a voice cue that form a command sequence corresponding to an application command within the command dictionary to determine which application command to issue. A command sequence that includes a particular gesture and a particular voice cue may be associated with an application command such that when that command sequence is provided, the associated application command is retrieved from the command dictionary.

The process or class of processes can be selected in a variety of ways. In many embodiments of the invention, gesture metadata associated with the gesture in the command sequence can be used to specify the application(s) targeted by the command sequence and/or provide semantics for the command sequence. For example, a V-shaped gesture can indicate that the following voice cue applies to the foreground (in focus) application. Alternatively, the gesture can simply change the vocal input state from not-listening to listening. The gesture can also provide semantics to the following voice cue such as indicating the user who is providing the voice cue. In other embodiments of the invention, command sequence metadata associated with the command sequence determines the selected application(s). For example, a command sequence can be associated with a search in a mapping application or a search in a restaurant review application.

A gesture can also be used for spatial localization. For instance it is possible to consider the situation in which the user is dictating some sentences into a text document. The location in the document in which the text has to be inserted has to be specified by the user. A vocal description of such location can be cumbersome. A pointing gesture (finger pointing towards the screen or moving a cursor remotely) can be used in order to specify such position in order to increase the efficiency of the natural user interface.

Although a specific process for interpreting command sequences where a gesture provides semantics for a subsequent voice cue is discussed above with respect to FIG. 4, any of a variety of processes can be utilized to interpret command sequences in accordance with embodiments of the invention.

### Interpreting Command Sequences of a Voice Cue and Subsequent Gesture

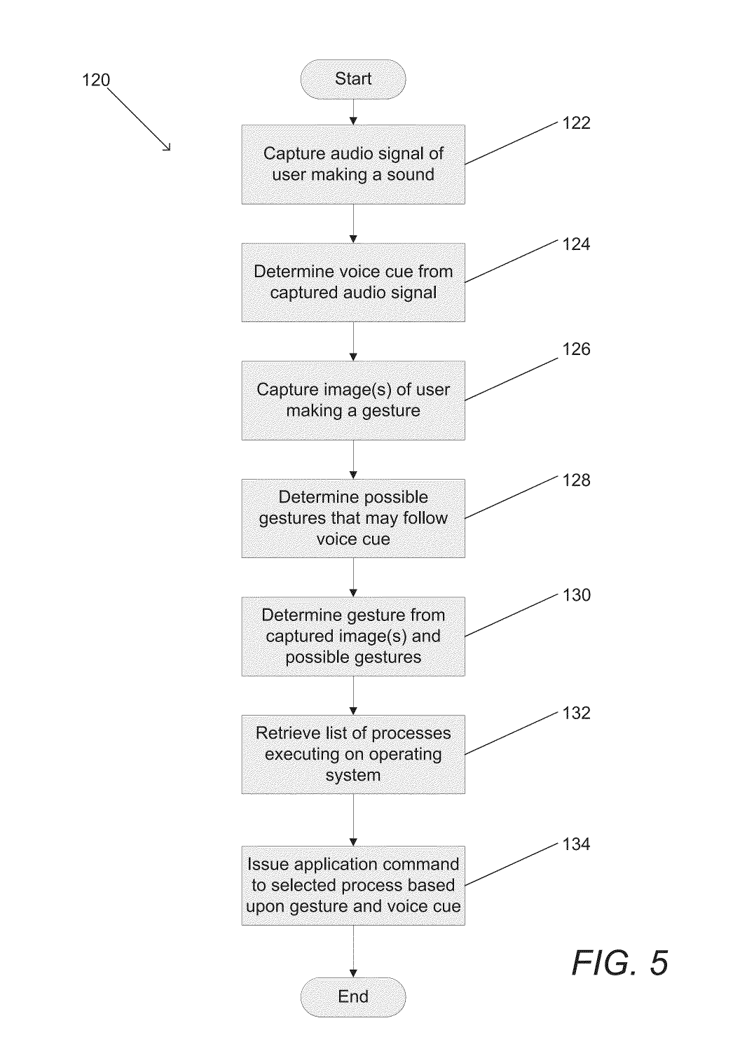

In many embodiments of the invention, a command sequence includes a voice and a subsequent gesture. The voice cue identified from an audio signal provides semantics for the subsequent gesture identified from image data. A process for interpreting command sequences where a voice cue provides semantics for a subsequent gesture in accordance with embodiments of the invention is illustrated in FIG. 5. Similar to the process described above with respect to FIG. 4, the process includes capturing (102) an audio signal of a user making a sound, such as a voice cue. However, in the process illustrated by FIG. 5, the voice cue precedes the gesture in the command sequence. In many embodiments of the invention, any of a variety of automatic speech recognition techniques can be used to identify (124) the voice cue from the audio signal. Techniques such as a Hidden Markov Model (HMM) can be used to identify the voice cue as discussed further above. Additionally, external resources such as a speech recognition API server can be utilized as discussed above.

The process includes capturing (126) one or more image(s) of a user making a gesture. As discussed above with respect to FIG. 4, image data can include one or more images acquired by one or more cameras. In several embodiments of the invention, voice cue metadata includes a list of potential gestures that may follow a voice cue in a command sequence. The list of potential gestures can be retrieved (128) and used in determining (130) the gesture from the image data. As discussed above with respect to the application of Hidden Markov Model in speech recognition, a gesture recognition algorithm can be tailored using the list of potential gestures to facilitate its search. Voice cue metadata associated with the voice cue identified above can also be used to assist in identifying the application to be affected by the identified gesture.

A list of processes running on the operating system is retrieved (132). As discussed above with respect to FIG. 4, any of a variety of other functions can be utilized to request a list of processes and/or process status from the operating system according to the capabilities of the system.

An application command is issued (134) to a selected process or class of processes from the list of processes based upon the command sequence of the gesture and voice cue. The application command can be determined in a variety of ways. As discussed further above, a command dictionary can contain database tables containing command sequences and associated application commands and metadata. The process can utilize metadata describing combinations of a voice cue and a gesture that form a command sequence corresponding to an application command within the command dictionary to determine which application command to issue. A command sequence that includes a particular voice cue and a particular gesture may be associated with an application command such that when that command sequence is provided, the associated application command is retrieved from the command dictionary.

The process or class of processes can be selected in a variety of ways. In many embodiments of the invention, voice cue metadata associated with the voice cue in the command sequence can be used to specify the application(s) targeted by the command sequence and/or provide semantics for the command sequence. For example, a voice cue of “volume” can specify that the following rolling gesture is applied to increase volume of the sound mixer in an operating system or the volume of a music player application. Saying “track” as a voice cue can specify that a rolling gesture is applied to change tracks in a music player. Saying “scroll” can cause the rolling gesture to scroll a web page or text screen. The voice cue “multimedia” can cause a multiple-selection interface in the GUI (graphical user interface) to appear with selections such as “videos,” “pictures,” and “music,” and the following gesture can indicate which selection is chosen. In other embodiments of the invention, command sequence metadata associated with the command sequence determines the selected application(s). In several embodiments, command sequence metadata associated with the command sequence identified based upon the combination of the voice cue and the gesture can be used to identify the application(s) targeted by the command sequence.

Although a specific process for interpreting command sequences where a voice cue provides semantics for a subsequent gesture is discussed above with respect to FIG. 5, any of a variety of processes can be utilized to interpret command sequences in accordance with embodiments of the invention.

### Interpreting Command Sequences of a Simultaneous Gesture and Voice Cue

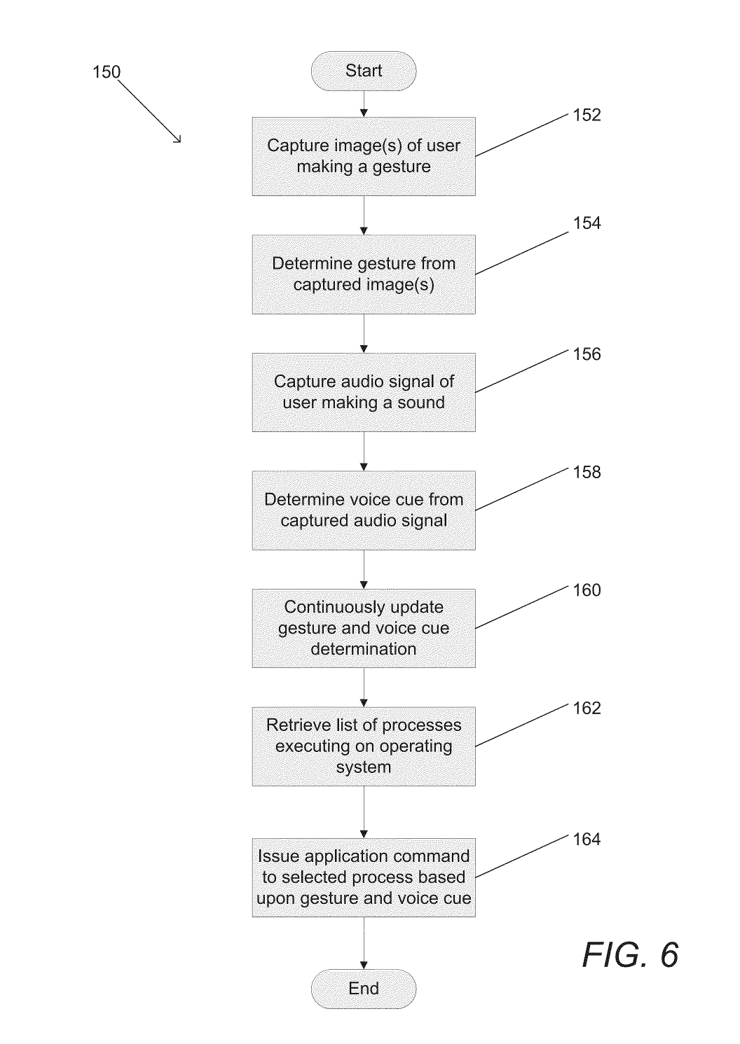

In many embodiments of the invention, a command sequence includes a voice cue and a gesture input combination that can be provided in any order and/or simultaneously. The voice cue identified from an audio signal and the gesture identified from image data are continuously updated from the audio signal and image data. A process for interpreting command sequences where a simultaneous voice cue and gesture provide semantics for the command sequence in accordance with embodiments of the invention is illustrated in FIG. 6. Similar to the processes described above with respect to FIGS. 4 and 5, the process includes capturing (152) image(s) of a user making a gesture. A gesture is determined (154) from the image data. The process further includes capturing (156) an audio signal of a user making a sound, such as a voice cue. In many embodiments of the invention, any of a variety of automatic speech recognition techniques can be used to identify (158) the voice cue from the audio signal. Techniques such as a Hidden Markov Model (HMM) can be used to identify the voice cue as discussed further above. Additionally, external resources such as a speech recognition API server can be utilized as discussed above.

The image data and audio signal are continuously received such that the gesture and voice cue determination can continuously be updated (160). In this way, semantics can be determined by the ongoing status of each input. For instance, a voice cue can indicate the beginning and/or end of a gesture or sequence of gestures. Conversely, a gesture can indicate the beginning and/or end of a voice cue or sequence of voice cues. Referring again to the V-shape hand gesture discussed above, holding the V-shape gesture while providing a voice cue is an example of operation where the hand gesture defines a continuous period for processing the voice command.

A list of processes running on the operating system is retrieved (162). As discussed further above, any of a variety of other functions can be utilized to request a list of processes and/or process status from the operating system according to the capabilities of the system.

An application command is issued (164) to a selected process or class or processes from the list of processes based upon the command sequence of the gesture and voice cue. The application command can be determined in a variety of ways such as those described further above with respect to FIGS. 4 and 5. Metadata associated with a command sequence in a command dictionary can be utilized to determine the application command to issue. The process or class of processes can be selected in a variety of ways such as those described further above with respect to FIGS. 4 and 5. Metadata associated with a command sequence, or with a gesture or voice cue in the command sequence, can be utilized to determine the process(es) to which an application command is issued.

Although a specific process for interpreting command sequences where a command sequence includes a simultaneous voice cue and a gesture is discussed above with respect to FIG. 6, any of a variety of processes can be utilized to interpret command sequences in accordance with embodiments of the invention.

Although the present invention has been described in certain specific aspects, many additional modifications and variations would be apparent to those skilled in the art. It is therefore to be understood that the present invention may be practiced otherwise than specifically described, including various changes in the implementation such as utilizing encoders and decoders that support features beyond those specified within a particular standard with which they comply, without departing from the scope and spirit of the present invention. Thus, embodiments of the present invention should be considered in all respects as illustrative and not restrictive.

What is claimed is:

1. A method for interpreting a command sequence that includes a gesture and a voice cue to issue an application command to at least one process using a natural interaction user interface system that includes a processor and memory containing a command dictionary, the method comprising:
receiving image data using a natural interaction user interface system;
receiving an audio signal using a natural interaction user interface system;
selecting, using a natural interaction user interface system, an application command from a command dictionary of application commands based upon:
a gesture identified using the image data;
a voice cue identified using the audio signal; and
metadata describing combinations of a gesture and a voice cue that form a command sequence corresponding to an application command within the command dictionary;
retrieving a list of processes running on an operating system using a natural interaction user interface system;
selecting at least one process from the list of processes based upon the selected application command and the metadata using a natural interaction user interface system, where the metadata further comprises information identifying at least one process targeted by the application command; and
issuing an application command to the selected at least one process using a natural interaction user interface system.

2. The method of claim 1, wherein:
the metadata comprises gesture metadata, where the gesture metadata identifies a plurality of voice cues that combine with a gesture to form a command sequence corresponding to an application command within the command dictionary; and
selecting an application command from a dictionary of application commands further comprises:
identifying a gesture using the image data; and
identifying a voice cue from the plurality of voice cues using the audio signal and the gesture metadata.

3. The method of claim 2, wherein gesture metadata further comprises information identifying at least one process to target with an application command associated with a command sequence containing a gesture and selecting at least one process from the list of processes using a natural interaction user interface system further comprises selecting at least one process based upon the gesture metadata.

4. The method of claim 1, wherein:
the metadata comprises voice cue metadata, where the voice cue metadata identifies a plurality of gestures that combine with a voice cue to form a command sequence corresponding to an application command within the command dictionary; and
selecting an application command from a dictionary of application commands further comprises:
identifying a voice cue using the audio signal; and
identifying a gesture from the plurality of gestures using the image data and the voice cue metadata.

5. The method of claim 4, wherein voice cue metadata further comprises information identifying at least one process to target with an application command associated with a command sequence containing a voice cue and selecting at least one process from the list of processes using a natural interaction user interface system further comprises selecting at least one process based upon the voice cue metadata.

6. The method of claim 1, wherein selecting an application command from a dictionary of application commands further comprises:
identifying a gesture using the image data;
identifying a voice cue using the audio signal;
continuously updating the image data and the identification of the gesture; and
continuously updating the audio signal and the identification of the voice cue.

7. The method of claim 1, wherein receiving image data further comprises capturing image data using at least one camera.

8. The method of claim 7, wherein receiving image data further comprises capturing image data using at least two cameras.

9. The method of claim 7, wherein the image data includes depth information that can be used to identify a three-dimensional gesture.

10. The method of claim 9, wherein the depth information comprises a depth map.

11. The method of claim 1, wherein receiving image data further comprises capturing image data using an ultrasonic sensor.

12. The method of claim 1, wherein receiving image data further comprises capturing image data using one or more devices in which multiple view-points are included in a single chip.

13. The method of claim 12, wherein at least one device in which multiple view-points are included in a single chip is a computational camera.

14. The method of claim 1, wherein receiving an audio signal further comprises capturing an audio signal using at least one microphone.

15. The method of claim 1, wherein the gesture is a static gesture.

16. The method of claim 1, wherein the image data includes a sequence of multiple images captured over time and the gesture is a dynamic gesture.

17. The method of claim 1, further comprising:
retrieving command sequence metadata based upon the gesture and the voice cue, wherein the command sequence metadata comprises information that can be used to identify at least one application to target with an application command associated with the command sequence; and
wherein selecting at least one process from the list of processes using a natural interaction user interface system further comprises selecting at least one process based upon the command sequence metadata.

18. The method of claim 1, wherein the natural interaction user interface system includes a user device and a recognition server that can communicate over a network.

19. A natural interaction user interface system for providing user input to an operating system, comprising:
a processor;
memory, wherein the memory comprises:
an operating system;
a user application;
a natural interaction interface application;
a database comprising metadata and a command dictionary of application commands;
a display;
at least one camera configured to capture image data; and
at least one microphone configured to generate an audio signal;
wherein the processor is configured by the natural interaction interface application to:
select an application command from the command dictionary of application commands based upon:
a gesture identified using the image data;
a voice cue identified using the audio signal; and
metadata describing combinations of a gesture and a voice cue that form a command sequence corresponding to an application command within the command dictionary;
retrieve a list of processes running on an operating system;
select at least one process from the list of processes based upon a selected application command and the metadata, where the metadata further comprises information identifying at least one process targeted by an application command; and
issue a selected application command to the selected at least one process.

20. The natural interaction user interface system of claim 19, wherein:
the metadata comprises gesture metadata, where the gesture metadata identifies a plurality of voice cues that combine with a gesture to form a command sequence corresponding to an application command within the command dictionary; and
wherein the processor being configured to select an application command from a dictionary of application commands further comprises the processor being configured to:
identify a gesture using the image data; and
identify a voice cue from the plurality of voice cues using the audio signal and the gesture metadata.

21. The natural interaction user interface system of claim 20, wherein gesture metadata further comprises information identifying at least one process to target with an application command associated with a command sequence containing the gesture and the processor being configured to select at least one process from the list of processes further comprises the processor being configured to select at least one process based upon gesture metadata.

22. The natural interaction user interface system of claim 19, wherein:
the metadata comprises voice cue metadata, where the voice cue metadata identifies a plurality of gestures that combine with a voice cue to form a command sequence corresponding to an application command within the command dictionary; and
the processor being configured to select an application command from a dictionary of application commands further comprises the processor being configured to:
identify a voice cue using an audio signal;
identify a gesture from the plurality of gestures using image data and gesture metadata.

23. The natural interaction user interface system of claim 22, wherein voice cue metadata further comprises information identifying at least one process to target with an application command associated with a command sequence containing the voice cue and the processor being configured to select at least one process from the list of processes further comprises the processor being configured to select at least one process based upon voice cue metadata.

24. The natural interaction user interface system of claim 19, wherein the processor being configured to select an application command from a dictionary of application commands further comprises the processor being configured to:
identify a gesture using the image data;
identify a voice cue using the audio signal;
continuously update the image data and the identification of the gesture; and
continuously update the audio signal and the identification of the voice cue.

25. The natural interaction user interface system of claim 19, wherein the at least one camera configured to capture image data includes at least two cameras.

26. The natural interaction user interface system of claim 19, wherein the image data includes depth information that can be used to identify three-dimensional gestures.

27. The natural interaction user interface system of claim 26, wherein the image data comprises a depth map.

28. The natural interaction user interface system of claim 19, wherein the image data includes information at ultrasonic wavelengths.

29. The natural interaction user interface system of claim 19, wherein at least one of the at least one cameras is configured to capture image data using one or more devices in which multiple view-points are included in a single chip.

30. The natural interaction user interface system of claim 29, wherein at least one camera is a computational camera.

31. The natural interaction user interface system of claim 19, wherein the gesture is a static gesture.

32. The natural interaction user interface system of claim 19, wherein the image data includes multiple images and the gesture is a dynamic gesture.

33. The natural interaction user interface system of claim 19, wherein the processor is further configured by the natural interaction interface application to:
retrieve command sequence metadata from the database based upon a gesture and a voice cue, wherein the command sequence metadata comprises information that can be used to identify at least one application to target with an application command associated with the command sequence; and
wherein the processor being configured to select at least one process from the list of processes using a natural interaction user interface system further comprises the processor being configured to select at least one process based upon command sequence metadata.

34. The natural interaction user interface system of claim 19, wherein the processor is further configured by the natural interaction interface application to transmit the image data to a recognition server and the gesture is identified using the image data by a recognition server.

35. The natural interaction user interface system of claim 19, wherein the processor is further configured by the natural interaction interface application to transmit the audio signal to a recognition server and the voice cue is identified using the audio signal by a recognition server.
